(19) United States
(12) Patent Application Publication
(10) Pub. No.: US 2026/0075645 A1
(43) Pub. Date: Mar. 12, 2026

(54) CARRIER AGGREGATION ASSIGNMENT USING BACKHAUL LIMITATIONS

(71) Applicant: T-MOBILE INNOVATIONS LLC, Overland Park, KS (US)

(72) Inventors: Roopesh Kumar POLAGANGA, Bothell, WA (US); Samir PATEL, Plano, TX (US)

(21) Appl. No.: 18/830,779

(22) Filed: Sep. 11, 2024

(51) Int. Cl. H04W 74/0808; H04L 5/00

(52) U.S. Cl. CPC H04W 74/0808; H04L 5/0035

(57) ABSTRACT

Systems and methods are provided for dynamically assigning carrier aggregation to user equipment (UE) utilizing backhaul limits as an initial threshold. Backhaul limits are bottlenecks for data in telecommunications networks. By assigning carrier aggregation based on backhaul limit constraints, networks can optimize carrier aggregation activation and optimize resource allocation within the network. Networks stand to benefit from discontinuing blind activation of carrier aggregation when the addition of more cells assigned to the UE do not impact the maximum data throughput achieved in view of the backhaul limits experienced by the network at a given time.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for intelligently and dynamically assigned NRCA (New Radio Carrier Aggregation) based on evaluation of backhaul limitations. More particularly, in aspects set forth herein, systems and methods enable activation or de-activation of NRCA based on backhaul limitations in order to optimize NRCA assignment and allocation of network resources.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for dynamically configuring carrier aggregation, in accordance with aspects herein;

FIG. 3 depicts a flow diagram of a method for dynamically configuring carrier aggregation, in accordance with aspects herein;

FIG. 4 depicts a flow diagram of a method for dynamically configuring carrier aggregation, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to dynamically configuring carrier aggregation. Generally, carrier aggregation (CA) or, in the case of 5G, New Radio Carrier Aggregation (NRCA), is automatically and blindly configured when a device attaches to a network. The blind configuration is based only on layers present in a network and UE capabilities. Subsequent NRCA activations (after the UE is configured) are done based on buffer thresholds for the UE, radio conditions of each layer based on UE measurement reports, or based on no metrics at all. Current implementation of NRCA does not account for any loss or limitations on backhaul, which impacts the overall experience and performance of the network.

Backhaul transport is the connectivity link between the base station and core network (such as AMF/SMF) that carries both data and signaling across the backend. A cell site router (CSR) connects the base station with a backhaul circuit and routes packets accordingly. These backhaul circuits typically come in predefined capacity ranges (e.g., 1G, 10G circuit). There are scenarios where the backhaul becomes unavailable or overloaded (e.g., a bottleneck) such as during intermittent outages that occur in backhaul that can result in temporary loss of full backhaul capacity that it typically carries. A lower limit on backhaul capacity can also act as a bottleneck to provide peak speeds even with spectrum-rich radio access.

Accordingly, a first aspect of the present disclosure is directed to a system for dynamically configuring carrier aggregation. The system comprises one or more processors; and one or more computer-readable media storing computer-usable instructions that, when executed by the one or more processors, cause the one or more processors to identify a peak data rate for a cell site; identify a backhaul limit for the cell site; determine that the backhaul limit is less than the peak data rate; receive a request from a user equipment (UE) for an adjusted data rate exceeding a current data rate experienced by the UE; determine that the adjusted data rate is greater than the backhaul limit; and communicate an instruction to the UE preventing activation of carrier aggregation configuration for the UE.

A second aspect of the present disclosure is directed to a method for dynamically configuring carrier aggregation. The method comprises identifying a peak data rate for a cell site; identifying a backhaul limit for the cell site; determining that the backhaul limit is less than the peak data rate; receiving a request from a user equipment (UE) for an adjusted data rate exceeding a current data rate experienced by the UE; determining that the adjusted data rate is greater than the backhaul limit; and communicating an instruction to the UE preventing activation of carrier aggregation configuration for the UE.

Another aspect of the present disclosure is directed to a method for dynamically configuring carrier aggregation. The method comprises identifying a peak data rate and a backhaul limit for a cell site; determining that the backhaul limit is less than the peak data rate at a first time; receiving a request from a user equipment (UE) for an adjusted data rate exceeding a current data rate experienced by the UE; determining that the adjusted data rate is greater than the backhaul limit; communicating an instruction to the UE preventing activation of carrier aggregation configuration for the UE; determining that the backhaul limit is greater than the peak data rate at a second time after the first time; and enabling carrier aggregation for the UE requesting the adjusted data rate exceeding the current data rate experienced by the UE.

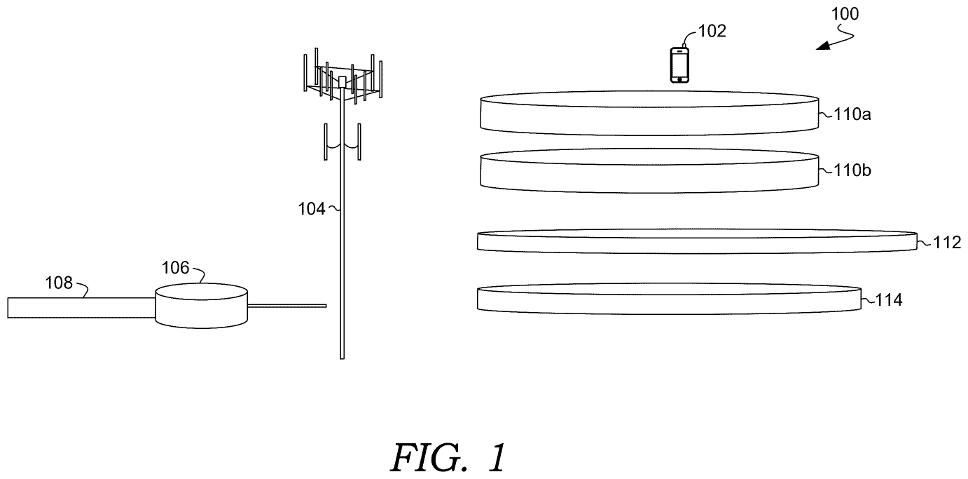

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 500 described with respect to FIG. 5, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

The base station 104 shown in FIG. 1 communicates with UE 102 as well as cell site router 106. Cell site router 106 relays information between a backhaul circuit 108 and the base station 104, such as the backhaul limit. The backhaul limit, as used herein, refers generally to a backhaul data limit possible for the backhaul circuit 108 at any point in time. A backhaul circuit can have a maximum data limit that is the maximum data limit possible by the backhaul circuit in ideal circumstances. In less than ideal circumstances (e.g., intermittent outages, overloaded requests, etc.) the backhaul circuit can experience a decrease in the backhaul limit, such that the maximum data limit is not achievable. The base station 104 monitors the backhaul circuit 108 at predetermined time intervals that are system configurable (e.g., hourly, every two hours, etc.).

The network environment 100 also illustrates exemplary layers of the network. Layers 110a and 110b are meant to illustrate an n41 layer. In this instance, 110a is provided as a primary cell (Pcell) and the second n41 layer 110b is a secondary cell (Scell). Additionally, layer 112 illustrates an exemplary n71 layer while layer 114 is illustrative of the LTE band. While illustrative in nature, any of layers 110a, 110b, 112, and 114 can illustrate any layer/band of a network and are not limited to those specifically recited herein as associated with the respective layer. For instance, layer 110a could illustrate a band other than n41.

The base station 104 is aware of all available layers in a network system and of capacities associated therewith. For instance, in the illustrative example, assume that n41 carrier 1 band, shown as band 110a, is associated with 100 MHz of spectrum, n41 carrier 2 band, shown as band 110b, is associated with 80 MHz of spectrum, n71 band 112 is associated with 15 MHz, and LTE band 114 is associated with 20 MHz. Thus, for some devices that are three carrier cell capable, 195 MHz of spectrum may be available utilizing bands 110a, 110b, and 112 (i.e., 100 MHz+80 MHz+15 MHz). Thus, a normal NRCA configuration using today's blind NRCA configuration for UE 102 (prior to an outage/backhaul limit issue) that is configured for 3 carrier components NRCA in a stand-alone NRCA network may be n41+n41+n71 (i.e., bands 110a, 110b, and 112). Stand-alone networks enable four component carriers (CC) for NRCA. In aspects, stand-alone networks enable five or more component carriers. In a non-stand-alone network (require a LTE band to anchor the network), the UE 102 may be assigned to LTE band 114 along with bands 110a and 110b.

In the event of an outage or a backhaul limitation (e.g., the backhaul limit is less than the peak data that could be experienced by the network), the component carriers may need to be assigned differently to optimize resources. For instance, if the backhaul limit is lower than the peak data limit of the network 100, carrier aggregation is not necessary since you cannot exceed the backhaul limit that is effectively a bottleneck in the system. The UE 102, in the above example, is assigned to bands 110a, 110b, and 112 (n41, n41, n71). If the backhaul limit is 120 MHz, there is no need to maintain a connection to layer 112 as both layers 110a and 110b already exceed the backhaul limit. Put in other words, layers 110a and 110b total 180 MHz, while the backhaul limit is equivalent to 120 MHz. Thus, the component carriers can be reduced from three to two by disabling NRCA assignment to band 112 for the UE 102.

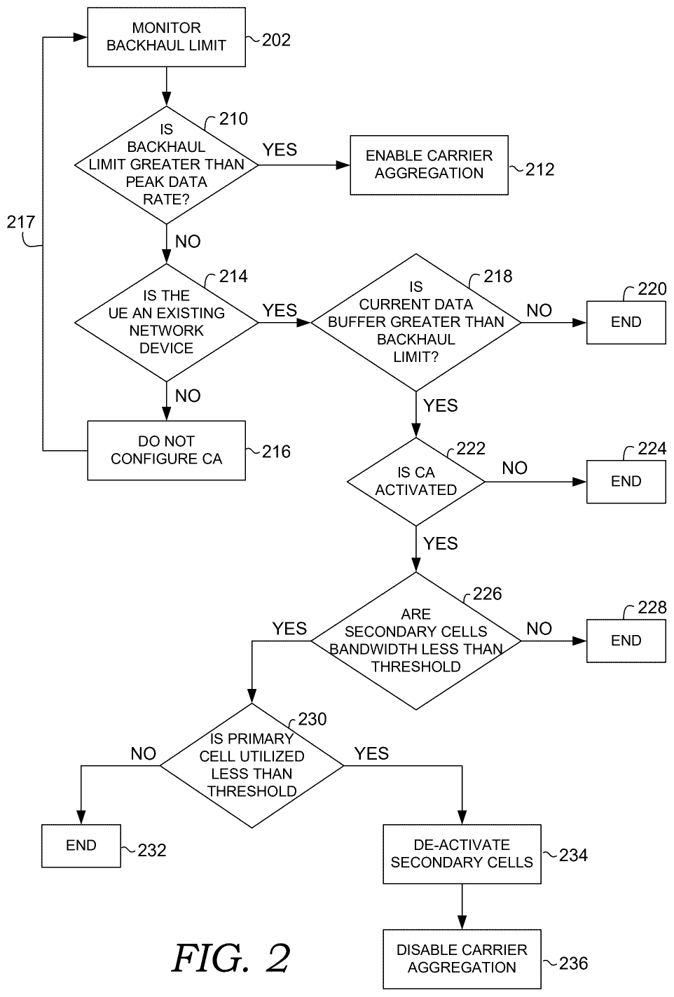

FIG. 2 is an exemplary flow diagram 200 that provides an exemplary overview of the description herein. Initially, at block 202, it is shown that the base station monitors the backhaul limit. This monitoring may be continuously or at predetermined time intervals (e.g., hourly). A determination is made during the monitoring whether the backhaul limit is greater than the peak data rate at block 210. If the backhaul limit is greater than the peak data rate, there is no bottleneck caused at the backhaul circuit and peak data limits are possible to be achieved for a UE. In that instance, carrier aggregation can be enabled at block 212.

If the backhaul limit is not greater than the peak data rate (e.g., the backhaul limit is less than the peak data rate), the system determines, at block 214, if the UE an existing network device. Each UE will either be a new device attaching to a network or an existed device that is already attached to the network. If the UE is not an existing network device (i.e., it is a new device to the network for a session), NRCA is not configured at block 216. The system blocks configuration of NRCA (or carrier aggregation) since the backhaul limit prevents the UE from experiencing peak data rates. Essentially, resources are not wasted identifying an appropriate carrier component to assign to the UE since data rates cannot exceed the backhaul limit detected at block 202. The method continues on via step 217 to continue monitoring the backhaul limit at block 202.

If the device is an existing network device at block 214, a determination is made at block 218 as to whether the current data buffer of the existing device is greater than the backhaul limit. If the current data buffer of the existing device is not greater than the backhaul limit, the method ends at block 220. If the current data buffer of the existing device is greater than the backhaul limit, the method identifies if carrier aggregation is currently enabled at block 222. If carrier aggregation is not currently enabled, the method ends at 224. This is due to the fact that the existing device's current data buffer is already greater than the backhaul limit so activating carrier aggregation to assign additional bands to the device will not change the current data buffer as it is limited by the backhaul limit.

If carrier aggregation is activated at block 222, the system determines, at block 226, if the secondary cells bandwidth is less than a predetermined threshold. If not, the method ends at block 228. If yes, the system determines if the primary cell is being utilized less than a predetermined utilization threshold at block 230. If not, the method ends at block 232. If both the secondary cell's bandwidth is less than a predetermined threshold and the primary cell is utilized less than a predetermined utilization threshold, the secondary cell(s) is deactivated at block 234 or un-assigned to the UE. Carrier aggregation is then disabled at block 236. Again, disabling carrier aggregation saves on valuable network resources that are not being utilized appropriately due to the backhaul limit bottleneck. This saves battery resources for the UE as it does not have to provide measurement reports for multiple bands. This also saves network resources as the network does not need to evaluate and manage carrier aggregation assignments that are not necessary.

Thus, newly incoming UEs do not experience NRCA configuration by default, as is traditionally done. Rather, if the UE requests a higher data buffer (e.g., a user is downloading a movie) than an operator defined threshold, the system can check if the overall aggregated speeds of the network (peak data rate) are lower than the latest backhaul limit. If yes, carrier aggregation can be enabled and a secondary cell assigned to the UE. The system can then continue to monitor until a maximum component carrier by the UE is reached. Alternatively, if the higher data buffer is higher than the latest backhaul limit, carrier aggregation is not enabled or activated and the primary cell is continued to be utilized for data transmission (i.e., no secondary cell is assigned).

Already-connected UEs can be handled differently. An example already-connected device may be a fixed wireless access (FWA) device. These devices are typically connected for longer periods of time and generally consume enormous amounts of data (e.g., 10 times more data than a smart phone device). For already-connected UEs, if the current data buffer is greater than the backhaul limit and NRCA is already configured or activated, the secondary cell bandwidth and primary cell utilization are evaluated. Specifically, if the secondary cell bandwidth is less than an operator-defined threshold (e.g., 20 MHz threshold) and the primary cell is utilized less than a predetermined utilization threshold (e.g., 70% utilization), then secondary cells are eliminated and the primary cell is used for data. This is due to the fact that the primary cell is being under-utilized so the component carriers can be reduced from two to one and NRCA can be disabled to effectively manage and optimize network resource allocation.

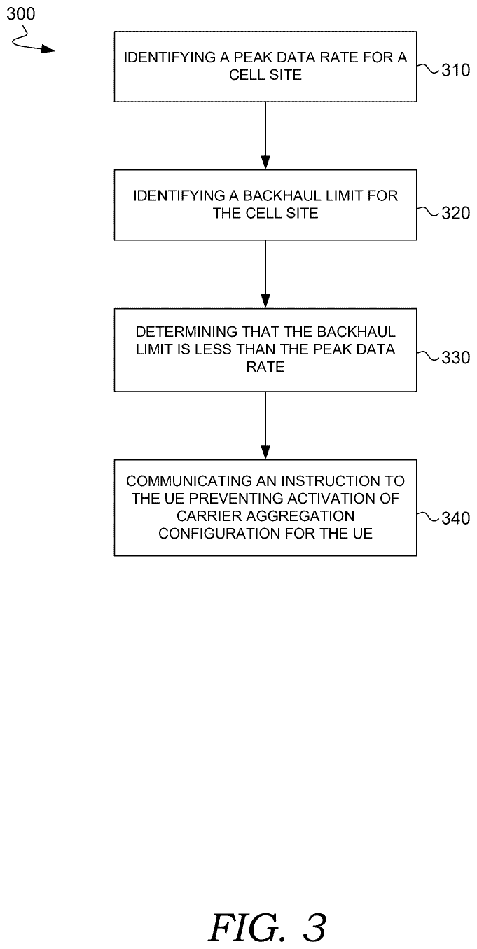

Turning to FIG. 3, a flow diagram 300 is provided illustrating a flow to dynamically configure carrier aggregation. Initially, at block 310, a peak data rate is identified for a cell site. This is possible because a cell site manager (base station) is aware of the available spectrum for any given site. At block 320, a backhaul limit is identified for the cell site. It is determined that the backhaul limit is less than the peak data rate at block 330. At block 340, an instruction is communicated that prevents activation of carrier aggregation configuration for the UE.

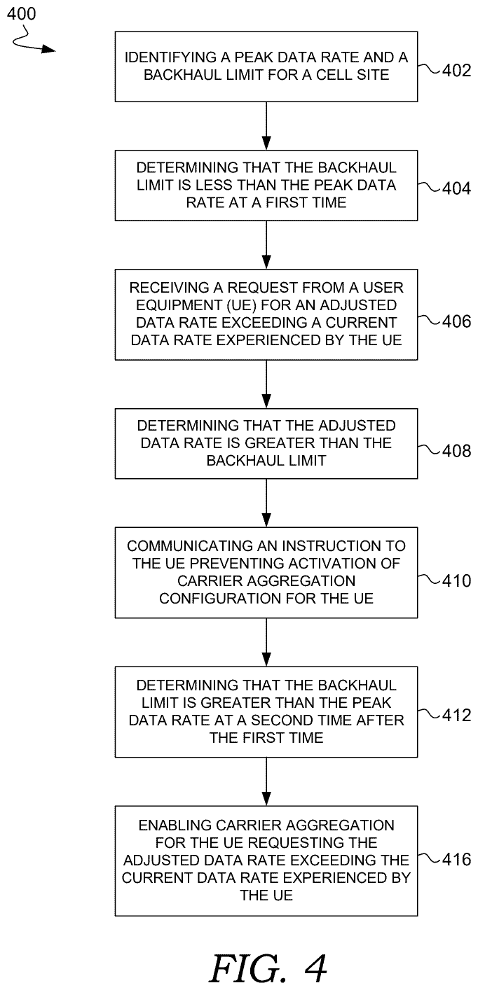

Referring to FIG. 4, a flow diagram 400 is provided illustrating a flow to dynamically configure carrier aggregation. Initially, at block 402, a peak data rate and a backhaul limit for a cell site are identified. At block 404, it is determined that the backhaul limit is less than the peak data rate at a first time. At block 406, a request is received from a user equipment (UE) for an adjusted data rate exceeding a current data rate experienced by the UE. It is determined that the adjusted data rate is greater than the backhaul limit at block 408. At block 410, an instruction is communicated that prevents activation of carrier aggregation configuration for the UE. At block 412, it is determined that the backhaul limit is greater than the peak data rate at a second time after the first time. Carrier aggregation is enabled for the UE requesting the adjusted data rate exceeding the current data rate experienced by the UE at block 416.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for dynamically configuring carrier aggregation, the system comprising:
one or more processors; and
one or more computer-readable media storing computer-usable instructions that, when executed by the one or more processors, cause the one or more processors to:
identify a peak data rate for a cell site;
identify a backhaul limit for the cell site;
determine that the backhaul limit is less than the peak data rate;
receive a request from a user equipment (UE) for an adjusted data rate exceeding a current data rate experienced by the UE;
determine that the adjusted data rate is greater than the backhaul limit; and
communicate an instruction to the UE preventing activation of carrier aggregation configuration for the UE.

2. The system of claim 1, wherein the UE requesting the adjusted data rate is capable of carrier aggregation but is not configured.

3. The system of claim 1, further comprising determine that the UE requesting the adjusted data rate is configured for three carrier cell aggregation.

4. The system of claim 3, wherein the three carrier cell aggregation comprises one primary cell and two secondary cells.

5. The system of claim 4, further comprising communicating an instruction to the UE to disable the three carrier cell aggregation.

6. The system of claim 5, wherein the secondary cell is disabled for the UE

7. The system of claim 1, wherein the processors monitor the backhaul limit and the peak data rate at predetermined time intervals.

8. A method for dynamically configuring carrier aggregation, the method comprising:
identifying a peak data rate for a cell site;
identifying a backhaul limit for the cell site;
determining that the backhaul limit is less than the peak data rate;
receiving a request from a user equipment (UE) for an adjusted data rate exceeding a current data rate experienced by the UE;
determining that the adjusted data rate is greater than the backhaul limit; and
communicating an instruction to the UE preventing activation of carrier aggregation configuration for the UE.

9. The method of claim 8, wherein the instruction preventing activation of carrier aggregation prevents the UE from being assigned to a secondary cell.

10. The method of claim 8, wherein the instruction preventing activation of carrier aggregation disables any secondary cell assignments active for the UE.

11. The method of claim 8, further comprising monitoring the backhaul limit and the peak data rate at predetermined time intervals.

12. The method of claim 11, wherein the prevention of carrier aggregation is terminated upon determining that the backhaul limit is greater than the peak data rate.

13. The method of claim 8, wherein carrier aggregation is enabled for the UE when the backhaul limit is greater than the peak data rate.

14. The method of claim 13, wherein carrier aggregation supports four carrier cells.

15. The method of claim 13, wherein carrier aggregation supports five or more carrier cells.

16. The method of claim 8, further comprising deactivating carrier aggregation for a connected UE when a primary cell utilization rate is below a predefined threshold.

17. A method for dynamically configuring carrier aggregation, the method comprising:
identifying a peak data rate and a backhaul limit for a cell site;
determining that the backhaul limit is less than the peak data rate at a first time;
receiving a request from a user equipment (UE) for an adjusted data rate exceeding a current data rate experienced by the UE;
determining that the adjusted data rate is greater than the backhaul limit;
communicating an instruction to the UE preventing activation of carrier aggregation configuration for the UE;
determining that the backhaul limit is greater than the peak data rate at a second time after the first time; and
enabling carrier aggregation for the UE requesting the adjusted data rate exceeding the current data rate experienced by the UE.

18. The method of claim 17, wherein enabling carrier aggregation for the UE comprises assigned the UE to a secondary cell.

19. The method of claim 17, further comprising monitoring the backhaul limit and the peak data rate at predetermined time intervals.

20. The method of claim 17, wherein carrier aggregation supports four or more carrier cells.
